(19) United States
(12) Patent Application Publication
(10) Pub. No.: US 2011/0102566 A1
(43) Pub. Date: May 5, 2011

(54) DENTAL IMAGING AND APPARATUS THEREFOR

(76) Inventors: Christian Zakian, Manchester (GB); Iain Pretty, Manchester (GB); Roger Ellwood, Manchester (GB)

(21) Appl. No.: 12/988,413

(22) PCT Filed: Apr. 23, 2009
(86) PCT No.: PCT/GB2009/001032

§ 371 Date: Jan. 4, 2011

(30) Foreign Application Priority Data
Apr. 25, 2008 (GB) 0807611.9

(51) Int. Cl. H04N 5/33; H04N 7/18

(52) U.S. Cl. 348/66; 348/E05.09; 348/E07.085

(57) ABSTRACT

Apparatus and method for imaging a tooth. The apparatus includes: illumination means arranged to generate first and second infra-red light; and image data acquisition means arranged for receiving infra-red light originating from the illumination means and returned from an illuminated tooth. The image data acquisition means includes infra-red pixel sensor means responsive to said returned infra-red light to generate image pixel values for a first image of the illuminated tooth using first infra-red light and for a second image of the illuminated tooth using second infra-red light. The apparatus further includes data processing means to use one or more image pixel values of the first image to calculate a first reflectance value, and to use one or more image pixel values of the second image to calculate a second reflectance value, and to determine from the first and second reflectance values a measure of the degree of enamel lesion (Se) and/or dentin lesion (Sd) present in the part.

The present invention relates to methods and apparatus for the imaging of teeth and particularly, though not exclusively, for imaging lesions or for processing such data.

Dental caries is a dynamic disease characterised by tooth demineralization leading to an increase in the porosity of the enamel surface. The result is commonly known as “white spots” and is due to the white appearance created by the increase of refraction index of de-mineralized enamel. Leaving these lesions untreated can potentially lead to dental cavities which may reach the dentin and pulp of the tooth, and may eventually cause tooth loss. Occlusal and approximal tooth surfaces are among the sites most susceptible to de-mineralization due the acid attack from bacterial by-products.

The use of preventive agents to inhibit, or reverse, the de-mineralization process is predicated on the detection of lesions at an early stage. However, detecting early lesions is difficult.

Non-invasive detection of white spots may employ an estimation of surface porosity or mineral loss. Although radiographic methods are suitable for approximal surface lesion detection, they offer a reduced utility for screening early caries in occlusal surfaces. In addition, radiographic methods are not ideal due to the patient exposure to x-rays and to their lack of sensitivity at very early stages of the disease. Electrical caries monitoring enables only single point measurements.

Optical methods offer non-destructive monitoring of early tooth enamel de-mineralization.

Current imaging methods are based on the observation of changes in light transport within the tooth, namely absorption, scattering and/or fluorescence of light. Porous media scatters more the light than uniform media and stain tends to absorb the light. Trans-illumination is a method that looks for shadows created by pumping white light from one side of the tooth, as viewed from the opposite side. Such shadows may correspond to regions where light is scattered away and/or absorbed. This technique is difficult to employ quantitatively due to an uneven light distribution inside the tooth. Quantitative light fluorescence (QLF) is an imaging method that relies on the natural fluorescence by teeth. This fluorescence acts as an internal source of light that will try to escape through the surface of the tooth. With appropriate filters, one may observe the fluorescent light and may quantify the loss of mineral by visualizing dark patches or shadows produced by scattering and/or absorption of fluorescent light. However this technique is unsuitable when trying to discriminate between white spots and stain as both produce the similar effect.

Stain is commonly observed in the occlusal sites of teeth and this obscures the true detection of caries. Stain, therefore, is one of the most confounding factors in the detection of early caries lesions.

The present invention may desirably be employed in addressing or overcoming limitations in the prior art.

At its most general, the invention proposed is spectral measurement or imaging of a tooth in infra-red light (e.g. the near infra-red (NIR) spectral region) to produce data to enable identification and/or quantification of lesions on a tooth (e.g. occlusal tooth surfaces) using the spectral signatures of water absorption and the effect of porosity or demineralisation in the scattering of light by a tooth.

Near-infrared (NIR) light has a number of advantages for use in caries detection as compared to visible light since it suffers a lower degree absorption by stain and may penetrate deeper into a target tooth. Infra-red light may be employed (e.g. for Hyperspectral images) having a wavelength from 1000 nm to 2500 nm or more. The measured effects of infra-red light scattering by porous enamel and absorption thereof by water in dentin may be used to quantify the lesion extension and generate a caries score quantifying the degree of lesion. Analysis of the reflectance spectra of a target tooth illuminated by infra-red light may identify infra-red wavelength values, or ranges, of illuminating light returned from a tooth which exhibit reflectance values characteristic of scattering by porous or demineralized enamel or absorption thereof by water in the tooth (e.g. in dentin).

Histological examination of ground target teeth, made after the spectral measurements have shown that a caries score obtained according to an aspect of the invention, correlates significantly (Pearson's correlation of 0.89, p<0.01) with the corresponding histological score. Results yield a sensitivity of 75% and a specificity of 87.5% for enamel lesions and a sensitivity of 87.5% and a specificity of 100% for dentine lesions. The nature of the technique may provide a number of advantages including, desirably, the ability to spatially map the lesion distribution rather than only obtaining single-point measurements. The technique may be non-invasive, and/or non-contact and/or stain-insensitive.

Using light in the infra-red, e.g. near infra-red, region of the electromagnetic spectrum may overcome difficulties associated with scattering and absorption. Scattering in enamel is reduced and absorption by stain is low when infra-red light is employed. In fact, the scattering by enamel tissues reduces in the form of 1/λ³ laser wavelengths, λ, of 512 nm, 632 nm and 1053 nm at least. In addition, a higher transparency for 1310 nm wavelength light than for 1550 nm wavelength light in sound enamel suggests that water in the enamel attenuates the light at higher wavelengths. Stimulated lesions in tooth samples up to 6.75 mm in thickness can be resolved with a contrast ratio greater than 0.35 as between sound and demineralised enamel by using light of wavelength 1310 nm.

In a first of its aspects, the invention may provide apparatus for imaging a tooth including: illumination means arranged to generate first infra-red light with a first wavelength having a value within a range of values corresponding to an infra-red spectral absorption band of water (e.g. a spectral absorption band of water within a tooth, such as within enamel and/or within dentin), to generate second infra-red light with a second wavelength having a value within a range of values corresponding to an infra-red spectral reflection band characteristic of scattering from demineralised tooth enamel, and for illuminating a tooth therewith; image data acquisition means arranged for receiving infra-red light originating from the illumination means and returned from an illuminated tooth, and including infra-red pixel sensor means responsive to said returned infra-red light to generate image pixel values for a first image of the illuminated tooth using first infra-red light and not second infra-red light and to generate image pixel values for a second image of the illuminated tooth using second infra-red light and not first infra-red light, and to provide such image pixel values for use.

In this way, a signature of enamel lesion and/or a signature of dentin lesion may be sought in the spectrally selected image data for a tooth. In generating corresponding spectrally separated images, one may ensure that corresponding parts of each image may be identified as being associated with a common part of a tooth. This avoids misalignment or movement problems common in single-point data acquisition methods.

The infra-red pixel sensor array may comprise a CCD sensor array, or an InGaAs sensor array, or a sensor array such as a Mercury Cadmium Telluride (MCT) sensor array. An InGaAs sensor array may have a spectral response that covers up to 1700 nm whereas MCT sensor array may be responsive to infra-red wavelengths up to 2500 nm.

The infra-red pixel sensor array may be preferentially responsive to near-infrared wavelengths such as wavelengths in the range 0.8 microns to 2.5 microns, or 1.0 microns to 2.5 microns. The second wavelength may have a value which also falls within a range of values corresponding to an infra-red spectral absorption band of water (e.g. water in a tooth). The illumination means may be arranged to generate infra-red light with a third wavelength (other than the first or second wavelength) having a value within a range of values corresponding to an infra-red spectral absorption band of water (e.g. water in a tooth) and/or within a range of values corresponding to an infra-red spectral reflection band characteristic of scattering from demineralised tooth enamel.

The infra-red pixel sensor means may be arranged to be responsive to returned infra-red light originating from the illumination means to generate third image pixel values for a third image of the illuminated tooth using third infra-red light and not first nor second infra-red light. The apparatus may provide such third image pixel values for use, such as for use in detecting therein a signature of enamel lesion and/or dentin lesion. Most preferably, the infra-red pixel sensor means is responsive to returned infra-red light of a reference wavelength other than the first, second or third wavelengths, and originating from the illumination means, to generate reference image pixel values or for a reference image of the illuminated tooth using the reference infra-red light, and to provide them for use. The reference image pixel values may be used by the apparatus in, for example, normalising any image pixel value of any one, some or all of first, second or third images.

Preferably all of the first, second, third and reference infra-red wavelengths are less than 3 microns in size, e.g. within the near-IR band (e.g. from 0.8 microns to 2.5 microns). It has been found that infra-red wavelengths exceeding about 3 microns suffer significant attenuation in tooth enamel. This may reduce the intensity of illuminating infra-red light reaching dentin underneath such enamel, and may, to a varying extent, confound generation of a spectral signature in returned infra-red light characteristic of water within dentin indicative of dentin lesion.

The first wavelength may be a value chosen from the range 1410 nm-1470 nm. The second wavelength may be a value chosen from the range 1580 nm-1640 nm. The third wavelength may be a value chosen from the range 1880 nm-1940 nm. The reference wavelength may be a value chosen from the range 1060 nm-1120 nm. In each case, the wavelength may be within a narrower range being one half, or one third, or one sixth, of the size of the respective range given above, centred upon the same central wavelength as in the ranges given above.

The image data acquisition means may include optical input means via which the apparatus is arranged to receive infra-red light returned from an illuminated tooth in a direction substantially parallel with, or subtending an acute angle with respect to, a direction of illumination by the illumination means.

For example, back-scattering or back-reflection of illuminating light is preferred since the spectral signature of back-scattered light may be relatively strong in such circumstances when arising due to porosity in the tooth enamel. Also, this simplifies the arrangement and use of the apparatus and allows for a compact probe-like apparatus.

The illumination means may comprise optical output means with an optical axis along which the apparatus is arranged to output said infrared light to illuminate a tooth. The image data acquisition means may include optical input means comprising an optical axis along which the apparatus is arranged to receive infrared light returned from an illuminated tooth and which is substantially parallel to, or subtends an acute angle with respect to, the optical axis of the illumination means. Thus, back-scattering of infra-red light from the illumination means by an illuminated tooth, and to the optical input means may be provided. Preferably, the subtended angle is as small as is practicable, such as 5° or less, or less than 2° or less than 1°.

The image data acquisition means may include camera means including a pixel sensor array responsive to visible light returned from an illuminated tooth to form one or more image pixel values representing an image of at least a part of the tooth.

Accordingly, a “visible” image, i.e. representing what may be perceived by the human eye, may be simultaneously or contemporaneously created to permit images of the tooth formed using infra-red light to be compared with the “visible” image. The visible image may be co-registered or pixel-wise aligned with images formed using infra-red light to permit a pixel(s) selected in the “visible” image to directly identify a pixel(s) in an image of the same target formed using infra-red, by association with the same tooth part.

The apparatus may include infra-red optical filter means selectively operable in a first state to transmit infra-red light originating from the illumination means having said first wavelength and to substantially prevent transmission therethrough of infra-red light having said second wavelength, and in a second state to transmit infra-red light originating from the illumination means having said second wavelength and to substantially prevent transmission therethrough of infra-red light having said first wavelength. The infra-red optical filter means may be selectively operable in a third state to transmit infra-red light originating from the illumination means having said third wavelength and to substantially prevent transmission therethrough of infra-red light having any of said first wavelength and said second wavelength. The infra-red optical filter means may be selectively operable in a fourth state to transmit infra-red light originating from the illumination means having a reference (fourth) wavelength and to substantially prevent transmission therethrough of infra-red light having any of the first, second, or third wavelengths. Thus, spectrally separated and distinct first, second, third or reference infra-red image data may be acquired in this way, or otherwise. In alternatives, the illumination means may comprise means for separately (physically) generating infra-red light spectrally separated in this way for illuminating a tooth. Examples include an array of separate infra-red light sources (e.g. LEDs) each one of which is arranged to generate only one of the first, second, third and reference wavelengths. A visible light source may be provided separately in this way for use in enabling said “visible” images. In other examples, the infra-red pixel sensor means may comprise separate groups of pixel sensors in which each pixel sensor of a respective group is served by a dedicated one of a plurality of different infra-red optical filters. For example, four separate pixel sensor arrays may be provided each one of which is served by a respective one of four different infra-red optical filters arranged to transmit a respective one (only) of the first, second, third and reference infra-red wavelengths discussed above. The separate groups of pixel sensors may be arranged in a common overall pixel array (e.g. pixel sensor chip) overlaying separate individual sensor pixels of which (e.g. separately or in defined areas) are respective infra-red optical filters. In this example, the infra-red pixel sensor means may comprise an active-pixel sensor array in which individual pixels of the sensor are addressable such that pixel sensor signals from individual sensor pixels associated with a predetermined filter may be individually obtained and identified as such. The arrangement, in this example, may be analogous to the Bayer-type filter arrangement common in commercial digital cameras.

The infra-red optical filter means may be arranged in optical communication with the infra-red pixel sensor means to filter infra-red light directed to the infra-red pixel sensor means by the image data acquisition means.

The illumination means may include light-source means which may be operable to generate light including said first and second wavelengths and preferably said third wavelength and/or said reference wavelength (e.g. a broadband visible and near-IR source). The infra-red optical filter means may be arranged in optical communication with the light-source means to filter light generated by the light-source means for illuminating a tooth with infra-red radiation transmitted by the infra-red optical filter means.

The illumination means may comprise light-source means operable to generate light including said first and second wavelengths, (and preferably also the third and/or reference wavelength, and preferably visible wavelengths) and optical output means remotely or locally in optical communication with the light-source means via output optical waveguide means and arranged to output from the apparatus light generated by the light-source means to illuminate a tooth.

The apparatus may include optical input means remotely or locally in optical communication with the infra-red pixel sensor means via input optical means (e.g. optical waveguide means) and arranged to receive infra-red light returned from an illuminated tooth and to direct the returned infra-red light to the (local or remote) infra-red pixel sensor means for sensing thereby. The optical input means may not be remote, and may be housed within or otherwise an attachable or integral part of a unit or probe device containing the infra-red pixel sensor means. The illumination means may be similarly so housed within or attachable to the unit or probe device.

The apparatus may include an intra-oral probe (e.g. hand held) comprising the optical input means and the optical output means. This probe may be remote from image pixel sensor means and/or the illumination means, or the probe may include the image pixel sensor means and/or the illumination means.

For example, the probe may comprise any one, some or all of: the infra-red pixel sensor means; the illumination means; the infra-red optical filter means; any optical elements intermediate the infra-red pixel sensor means and the optical input means for collecting, focussing, collimating or otherwise preparing returned infra-red light. The probe may comprise such elements in a detachable unit attachable to the rest of the probe via attachment means or adapter means to place those elements in operable and optical communication with the optical input/output means.

Thus, different detachable such units may be provided having different operating characteristics (e.g. filters, illumination means or light source, sensor array etc) as required, enabling rapid and simple alteration of the operating characteristics of the probe as a whole.

The input optical waveguide means may comprise one or more optical fibres which collectively define an aligned optical fibre bundle.

The output optical waveguide means may comprise one or more optical fibres collectively defining an aligned optical bundle.

Optionally, at least a terminal end of the output optical waveguide means is adjacent the optical input means.

Optionally, the terminal end of the output optical waveguide comprises a bundle of optical fibres the ends of which form a ring circumscribing the output optical waveguide.

The illumination means may comprise first optical polarizer means for polarizing according to a first polarization axis infra-red radiation generated by the illumination means, and the image data acquisition means comprises second optical polarizer means for polarizing according to a second polarization axis transverse to the first polarization axis infra-red radiation received thereby from an illuminated tooth. The first and second optical polarizer means may be individually arranged to linearly polarise light, or to elliptically or circularly polarise light received thereby. Preferably, each is arranged to linearly (or optionally elliptically) polarise light, and may be such that the first and second optical polarisers define a pair of crossed polarisers. Specular reflections of light from tooth enamel tends to at least partially polarise un-polarised incident light, or put another way, specular reflections from a tooth surface preferentially select polarised light. Illuminating light returned from a tooth by a scattering process (e.g. multiple reflections) tends to de-polarise polarised incident light. Consequently, requiring returned light to pass through a polarising filter with a polarising characteristic converse to that of the filter through which illuminating light passed, to some extent removes from returned light those parts preserving the converse polarisation (e.g. specularly reflected light).

The optional use of circular polarisers to polarise light returned from an illuminated tooth has been found to enhance image contrast and definition.

The image data acquisition means may comprise focussing means arranged to form upon the infra-red pixel sensor means a real optical image using infra-red light received by the image data acquisition means from an illuminated tooth. Alternatively, or additionally, the image data acquisition means may comprise within-probe focussing means arranged to form a focused image upon a terminal optical input end of an aligned optical fibre bundle defining the input optical waveguide means, using return illuminating infra-red light. Most preferably the input end of the input optical waveguide comprises a flat surface collectively formed by a plurality of closely-packed ends of optical fibres. In this way, the light of a focused infra-red image may be transmitted, conveyed or guided from within the probe to the infra-red pixel sensor means (optionally remote). The focussing means (intra-probe or remote) may possess a controllable “zoom” function (e.g. a variable focal length) controllable by the user of the apparatus.

The optical filter means, the focussing means and infra-red pixel sensor means may be each in mutual optical communication and locally or remotely in optical communication with the optical input means (e.g. via said input optical waveguide means when remote).

Preferably, the illumination means is arranged to deliver full-field illumination to the tooth to be imaged, in other words to illuminate the whole area of the tooth which is to be imaged, e.g. substantially the whole exposed area of the tooth. In this way, the image pixel values of the area which is to be imaged can be generated without requiring the illumination means to be scanned across the area, as might be required if the illumination means only delivered only point-like illumination. The illumination means may be arranged to deliver full-field illumination e.g. by selection of suitable light source means and/or output optical waveguide means.

Similarly, it is also preferable for the infra-red pixel sensor means to be arranged to detect or capture a full-field image of the tooth, in other words to capture an image of the tooth without it having to be scanned across the tooth. For example, the infra-red pixel sensor means may comprise an infra-red pixel sensor array as described above. Thus, it is preferable for the apparatus to work on a full-field principle, in which the whole area which is to be imaged of the tooth is illuminated and a corresponding image captured, rather than scanning a point-like illumination across the tooth.

The apparatus may include image processing means arranged to receive said pixel image values for producing one or more of said first, second, third, reference and/or “visible-light” images therefrom.

The image processing means may be arranged to co-register a said first image and a said second image in respect of a common imaged subject, thereby to associate a given image pixel of the first image with a respective image pixel of the second image representing the same part of the imaged subject.

Such co-registration may be performed as between either or both of the first and second images and any or all of the third image and/or the reference infra-red image, and/or any visible image produced by the camera means.

The apparatus may include data processing means arranged in respect of a given part of the imaged subject to use one or more image pixel values of the first image to calculate a first reflectance value (R₁) associated with the part, and to use one or more image pixel values of the second image to calculate a second reflectance value (R₂) associated with the part, and to determine from the first and second reflectance values a measure of the degree of enamel lesion (Sₑ) and/or dentin lesion (S_{d}) present in the part. It should be clear that in some embodiments, the data processing means may be arranged to determine only a measure of the degree of enamel lesion (Sₑ) or only a measure of the degree of dentin lesion (S_{d}) present in the part. However, it is preferable for the data processing means to be arranged to determine both a measure of the degree of enamel lesion (Sₑ) and a measure of the degree of dentin lesion (S_{d}) present in the part.

The data processing means may be arranged, in respect of a given said part of the imaged subject, to use one or more image pixel values of the third image to calculate a third reflectance value (R₃) associated with the part, and to determine using first and/or second and/or third reflectance values; a measure of the degree of enamel lesion and/or dentin lesion.

The data processing means may be arranged to use said measure of the degree of enamel lesion (Sₑ) and said measure of the degree of dentin lesion (S_{d}) to calculate a measure (S_{carries}) of the degree of caries present in the part.

The spectral intensity of a pixel value may be normalised to the reflectance (R_{ref}) obtained at a reference wavelength (e.g. 1090 nm) which, preferably corresponds with the highest reflectance (least extinction). The degree of enamel, Sₑ, and dentin, S_{d}, lesions may be calculated as follows:

$${S}_{e} = {S}_{e}^{( 1 )} = \frac{{R}_{2}}{{R}_{ref}}$$

$$or$$

$${S}_{e} = {S}_{e}^{( 2 )} = \frac{{R}_{1} - {R}_{3}}{{R}_{ref}}$$

$${S}_{d} = \frac{{R}_{2} - {R}_{1}}{{R}_{ref}}$$

The equation for Sₑ⁽²⁾ results in a measure of lesion which has been found to be less susceptible to being influenced by, or confounded by, the effects of specular reflections at the ranges of wavelengths suggested above.

A caries score, S_{caries}, may be calculated as a combination of Sₑ and S_{d}. The combination is preferably a weighted algebraic sum of the two terms Sₑ and S_{d}, for example, with variable weight factor p:

$${S}_{caries} = p ( \frac{{S}_{e} - {K}_{e}}{{N}_{e}} ) + ( 1 - p ) ( 1 + \frac{{S}_{d} - {K}_{d}}{{N}_{d}} )$$

Here, Kₓ and Nₓ are an enamel (x:e) and dentin (x:d) score calibration offset and normalisation factor, respectively. In addition, one may specify that p=1 if

$$( 1 + \frac{{S}_{d} - {K}_{d}}{{N}_{d}} ) ≺ {S}_{dth}$$

where S_{dth} represents a dentin lesion threshold, otherwise p=0. Outliers and noise introduced into the data by specular reflections may be removed by limiting the values of the numerators in the equation for S_{caries} to the range 0<(Sₑ−Kₑ)<Mₑ and 0<(S_{d}−K_{d})<M_{d}; here Mₑ and M_{d} denote the upper limits. Values outside these limits may be set to zero. The computer means may be operable to perform any one, some or all of the above processing of data.

The infra-red pixel sensor means may be responsive to said returned infra-red light to generate image pixel values for a third image of the illuminated tooth using third infra-red light and not first infra-red light nor second infra-red light, and to provide such image pixel values for use.

The infra-red optical filter means may be selectively operable in a third state to transmit infra-red light originating from the illumination means having said third wavelength and to substantially prevent transmission therethrough of infra-red light having any of said first wavelength and said second wavelength.

The data processor means may be arranged to use one or more image pixel values of the third image to calculate a third reflectance value associated with the part, and to determine the measure of the degree of enamel lesion (Sₑ) and/or dentin lesion (S_{d}) present in the part using the third reflectance value.

The first wavelength value may be between 1300 nm and 1550 nm, and the second wavelength value may be between 1550 nm and 1800 nm. The first wavelength value may be between 1400 nm and 1500 nm, such as about 1440 nm, and the second wavelength value may be between 1550 nm and 1650 nm, such as about 1610 nm.

It is to be understood that the foregoing may represent a physical realisation or implementation of a corresponding method of imaging or measuring a property of a tooth, and that such corresponding methods are encompassed in by the invention.

In a second of its aspects, the invention may provide a method for imaging a tooth including: generating first infra-red light with a first wavelength having a value within a range of values corresponding to an infra-red spectral absorption band of water (e.g. a spectral absorption band of water within a tooth, such as within enamel and/or within dentin), generating second infra-red light with a second wavelength having a value within a range of values corresponding to an infra-red spectral reflection band characteristic of scattering from demineralised tooth enamel, and illuminating a tooth therewith; receiving at infra-red pixel sensor means first and second infra-red light returned from an illuminated tooth and therewith generating image pixel values for a first image of the illuminated tooth using first infra-red light and not second infra-red light and generating image pixel values for a second image of the illuminated tooth using second infra-red light and not first infra-red light, and providing such image pixel values for use.

The method may include receiving infra-red light returned from an illuminated tooth in a direction substantially parallel with, or subtending an acute angle with respect to, a direction of said illumination.

The method may include providing optical output means comprising an optical axis and therealong outputting said infrared light to illuminate a tooth, and providing optical input means comprising an optical axis and therealong receiving infrared light returned from an illuminated tooth for subsequent receipt at the infra-red pixel sensor means wherein the said optical axes are substantially parallel, or subtend an acute angle with respect to each other.

The method may include generating third image pixel values for a third image of the illuminated tooth using third infra-red light returned from the tooth and not first nor second infra-red light. The third image pixel values may be provided for use, such as for use in detecting therein a signature of enamel lesion and/or dentin lesion. The method may include receiving returned infra-red light of a reference wavelength other than the first, second or third wavelengths, and originating from the illumination means, and generating reference image pixel values or for a reference image of the illuminated tooth using the reference infra-red light, and to providing them for use. The reference image pixel values may be used by the apparatus in, for example, normalising any image pixel value of any one, some or all of first, second or third images.

Preferably all of the first, second, third and reference infra-red wavelengths are less than 3 microns in size, e.g. within the near-IR band (e.g. from 0.8 microns to 2.5 microns). The first wavelength may be a value chosen from the range 1410 nm-1470 nm. The second wavelength may be a value chosen from the range 1580 nm-1640 nm. The third wavelength may be a value chosen from the range 1880 nm-1940 nm. The reference wavelength may be a value chosen from the range 1060 nm-1120 nm. In each case, the wavelength may be within a narrower range being one half, or one third, or one sixth, of the size of the respective range given above, centred upon the same central wavelength as in the ranges given above.

The method may include forming an image representing at least a part of the illuminated tooth using visible light returned therefrom. The method may include co-registering the visible-light image or pixel-wise aligned with images formed using infra-red light to permit a pixel(s) selected in the “visible” image to directly identify a pixel(s) in an image of the same target formed using infra-red, by association with the same tooth part.

The method may include generating light for illuminating the tooth and in a first instance, filtering the light by transmitting through a filter means parts of said light having said first wavelength and substantially preventing transmission through the filter means of parts of said light having said second wavelength; and in a second instance, filtering the light by transmitting through the filter means parts of said light having said second wavelength and substantially preventing transmission through the filter means parts of said light having said first wavelength. The method may include filtering the light by transmitting infra-red light originating from the illumination means having said third wavelength and to substantially preventing transmission of infra-red light having any of said first wavelength and said second wavelength. The method may include filtering the light by transmitting infra-red light originating from the illumination means having a reference (fourth) wavelength and to substantially preventing transmission of infra-red light having any of the first, second, or third wavelengths.

The method may include performing said filtering on light directed to the infra-red pixel sensor means.

The method may include performing said filtering on light for illuminating a tooth.

The method may include generating said light remotely from, or locally at, said tooth, guiding the generating light to the proximity of the tooth, and illuminating the tooth with the guided light.

The method may include guiding said returned infra-red light to a location local to, or remote from, the point of receipt of the returned light and generating image pixel values using said returned, guided light at said local or remote location.

The method may be performed using an intra-oral probe.

The method may include polarizing according to a first polarization axis infra-red radiation generated for illuminating a tooth, and polarizing according to a second polarization axis transverse to the first polarization axis infra-red radiation returned from the illuminated tooth. The first and second polarization may be individually linear polarization, or to elliptical or circular polarization. Preferably, each is linear (or optionally elliptical) polarization, and the first and second polarization axes may together define crossed polarization axes.

The method may include forming upon an infra-red pixel sensor means a real optical image using said infra-red light returned from an illuminated tooth.

The method may include producing one or more of said first, second, third, reference and/or “visible-light” images from said returned light.

The method may include co-registering a said first image and a said second image in respect of a common imaged subject, thereby to associate a given image pixel of the first image with a respective image pixel of the second image representing the same part of the imaged subject. Such co-registration may be performed as between either or both of the first and second images and any or all of the third image and/or the reference infra-red image, and/or any visible image produced by the camera means.

Preferably, the method includes full-field illumination of the tooth, e.g. as described in connection with the first aspect of the invention. Preferably, the method includes detecting or capturing of a full-field image of the tooth, e.g. as described in connection with the first aspect of the invention.

The method may include, in respect of a given part of the imaged subject, calculating a first reflectance value associated with the part using one or more image pixel values of the first image, and calculating a second reflectance value associated with the part using one or more image pixel values of the second image, and determining from the first and second reflectance values a measure of the degree of enamel lesion (Sₑ) and/or dentin lesion (S_{d}) present in the part.

The method may include generating image pixel values for a third image of the illuminated tooth using third infra-red light returned from the tooth and not first infra-red light nor second infra-red light, and providing such image pixel values for use.

The method may include generating light for illuminating the tooth and in a third instance, filtering the light by transmitting through a filter means parts of said light having said third wavelength and substantially preventing transmission through the filter means of parts of said light having any of said first wavelength and said second wavelength.

The method may include calculating a third reflectance value associated with the part using one or more image pixel values of the third image, and determining the measure of the degree of enamel lesion (Sₑ) and/or dentin lesion (S_{d}) present in the part using the third reflectance value.

The first wavelength value may be between 1300 nm and 1550 nm, and the second wavelength value may be between 1550 nm and 1800 nm. The first wavelength value may be between 1400 nm and 1500 nm, such as 1440 nm or thereabouts, and the second wavelength value may be between 1550 nm and 1650 nm, such as 1610 nm or thereabouts.

The method may include, in respect of a given said part of the imaged subject, using one or more image pixel values of the third image to calculate a third reflectance value (R₃) associated with the part, and determining using first and/or second and/or third reflectance values, a measure of the degree of enamel lesion and/or dentin lesion.

The method may include calculating a measure (S_{carries}) of the degree of caries present in the part using said measure of the degree of enamel lesion (Sₑ) and said measure of the degree of dentin lesion (S_{d}). The spectral intensity of a pixel value may be normalised to the reflectance (R_{ref}) obtained at a reference wavelength (e.g. 1090 nm).

The degree of enamel, Sₑ, and dentin, S_{d}, lesions may be calculated according to the method as follows:

$${S}_{e} = {S}_{e}^{( 1 )} = \frac{{R}_{2}}{{R}_{ref}}$$

$$or$$

$${S}_{e} = {S}_{e}^{( 2 )} = \frac{{R}_{1} - {R}_{3}}{{R}_{ref}}$$

$${S}_{d} = \frac{{R}_{2} - {R}_{1}}{{R}_{ref}}$$

A caries score, S_{caries}, may be calculated as a combination of Sₑ and S_{d}. The combination is preferably a weighted algebraic sum of the two terms Sₑ and S_{d}, for example, with variable weight factor p:

$${S}_{caries} = p ( \frac{{S}_{e} - {K}_{e}}{{N}_{e}} ) + ( 1 - p ) ( 1 + \frac{{S}_{d} - {K}_{d}}{{N}_{d}} )$$

Here, Kₓ and Nₓ are an enamel (x:e) and dentin (x:d) score calibration offset and normalisation factor, respectively. In addition, one may specify that p=1 if

$$( 1 + \frac{{S}_{d} - {K}_{d}}{{N}_{d}} ) ≺ {S}_{dth}$$

where S_{dth} represents a dentin lesion threshold, otherwise p=0. Outliers and noise introduced into the data by specular reflections may be removed by limiting the values of the numerators in the equation for S_{caries} to the range 0<(Sₑ−Kₑ)<Mₑ and 0<(S_{d}−K_{d})<M_{d}; here Mₑ and M_{d} denote the upper limits. Values outside these limits may be set to zero.

In a third of its aspects, the invention may provide a computer programmed to implement the method of the second aspect of the invention.

In a fourth aspect, the invention may provide a computer program product comprising a computer-readable medium containing computer executable instructions which implement the method (in part or in full) of the invention in its second aspect when executed on a computer.

In a fifth aspect, the invention may provide a computer program containing computer executable instructions which implement the method of the second aspect when executed on a computer.

In a sixth of its aspects, the invention may provide an apparatus and/or quantitative method for dental caries detection, according to any aspect above, and may be employed to assist in determining the presence of occlusal enamel and/or dentin lesions.

The invention also includes any combination of the aspects and preferred features described except where such a combination is clearly impermissible or expressly avoided.

Preferred embodiments will now be described, by way of example only, with reference to the accompanying drawings of which:

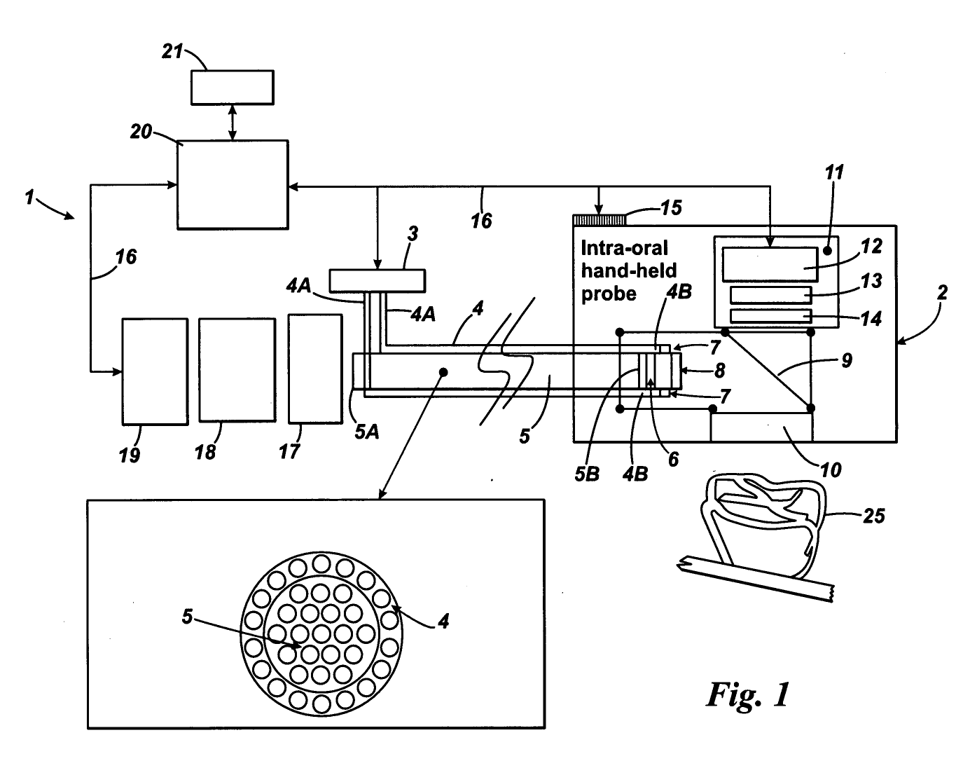

FIG. 1 schematically illustrates apparatus including a hand-held intra-oral probe and remote components;

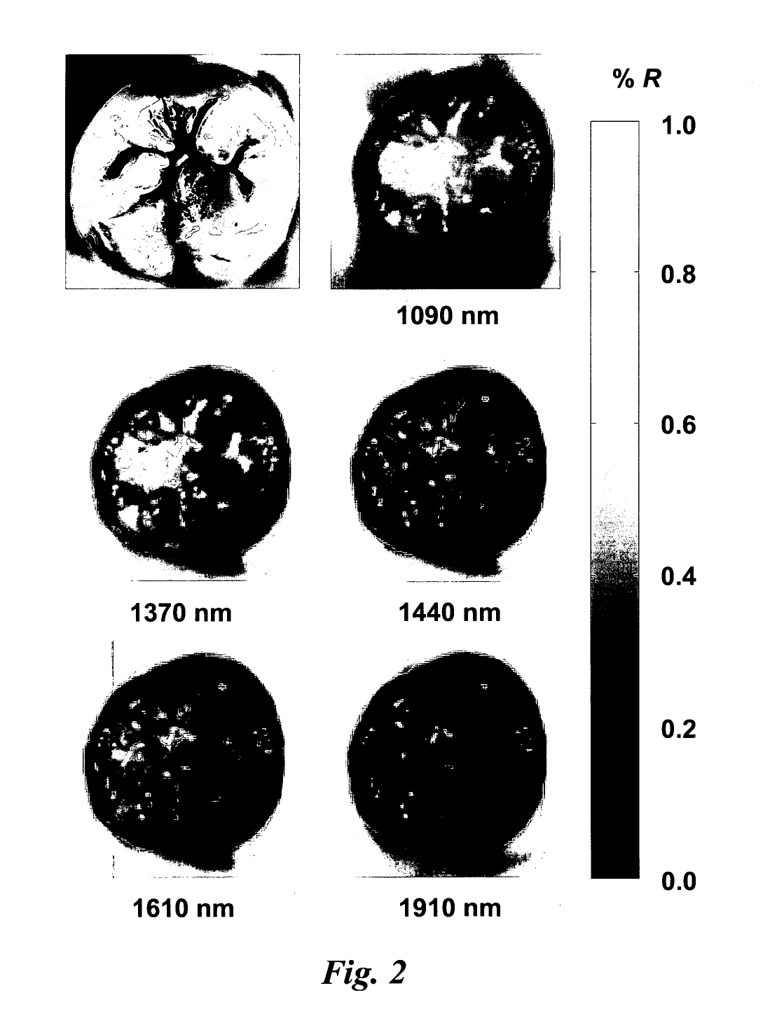

FIG. 2 illustrates a selection of spectral images. On the top left is a picture of a tooth taken using visible light. The remaining reflectance images are obtained using near infra-red (NIR) light at the wavelengths indicated;

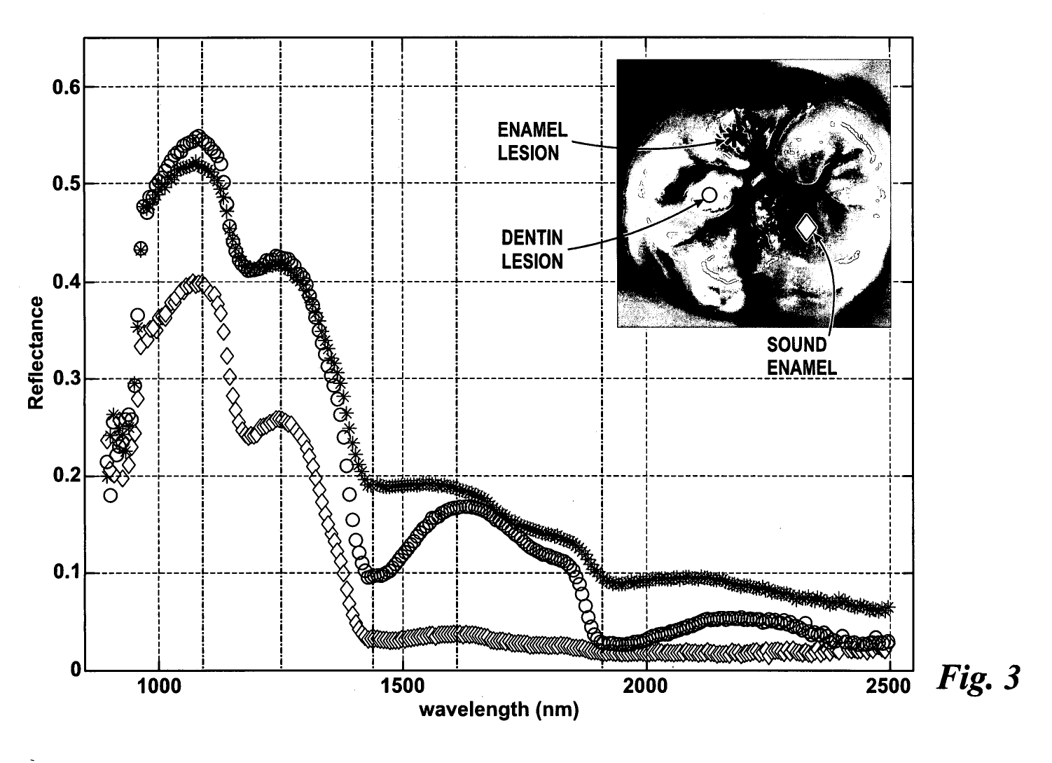

FIG. 3 illustrates NIR spectral reflectance curves from an occlusal tooth surface. The figure shows the reflectance for sound enamel (diamond symbols), an enamel lesion region (asterisks *) and a dentin lesion region (circles ∘). The inset picture shows the location of the points selected within the tooth for this example. Vertical dotted lines in the graph of FIG. 3 indicate the wavelengths chosen for the NIR images of FIG. 2;

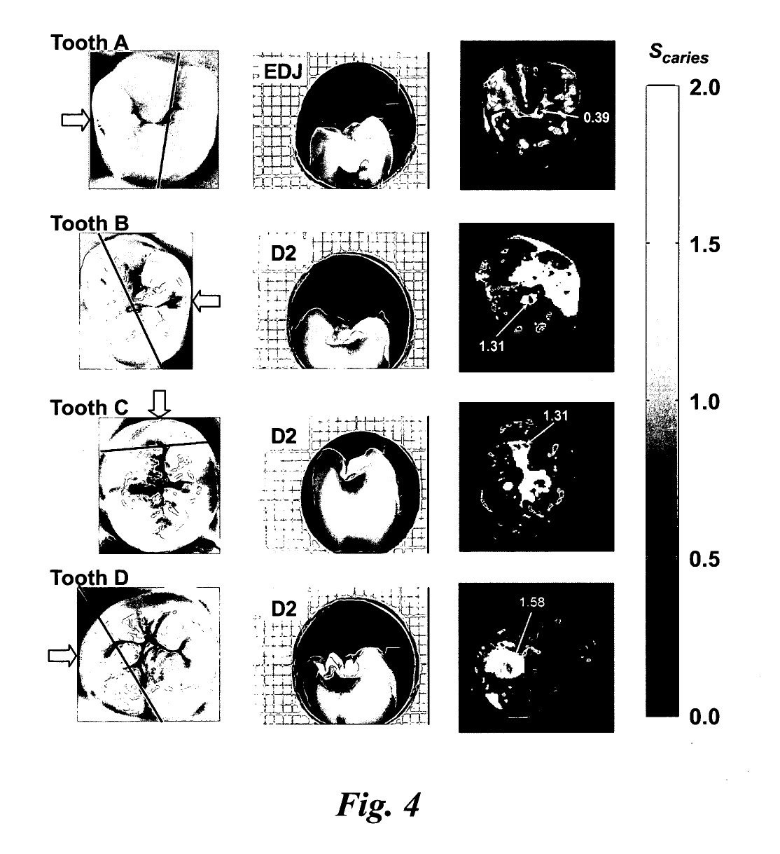

FIG. 4 illustrates examples of teeth with different carious lesions. Left-hand images show a picture for each tooth obtained in visible light. Central images show the corresponding histological section which is indicated by the straight line traversing the tooth picture, and an arrow indicates the point of view of the section. The right-hand images show the NIR caries maps, spatially scored using a numerical carries score, S_{caries}, for each tooth;

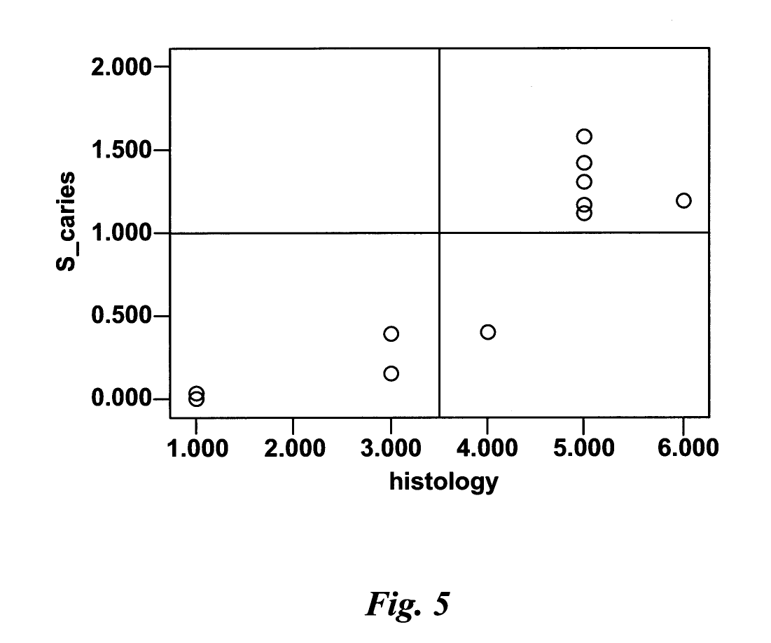

FIG. 5 illustrates a correlation plot of the histological score and the average maximum NIR caries score, S_{caries} within the map region corresponding to the histological section;

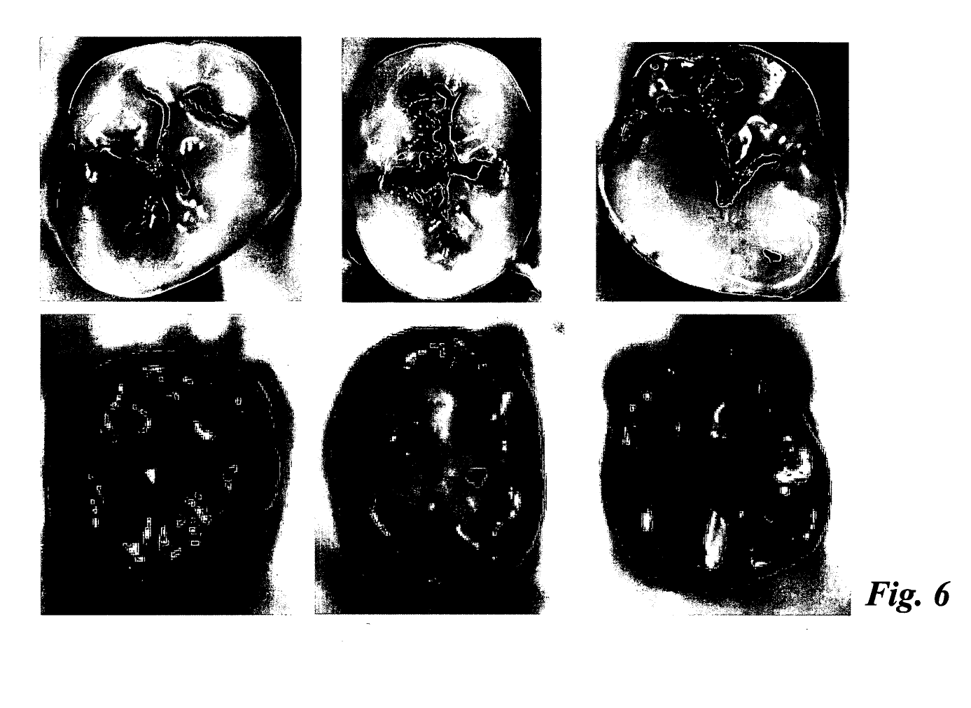

FIG. 6 illustrates NIR images of highly stained occlusal tooth surfaces taken using light of 1250 nm wavelength. The absorption by stain is minimal;

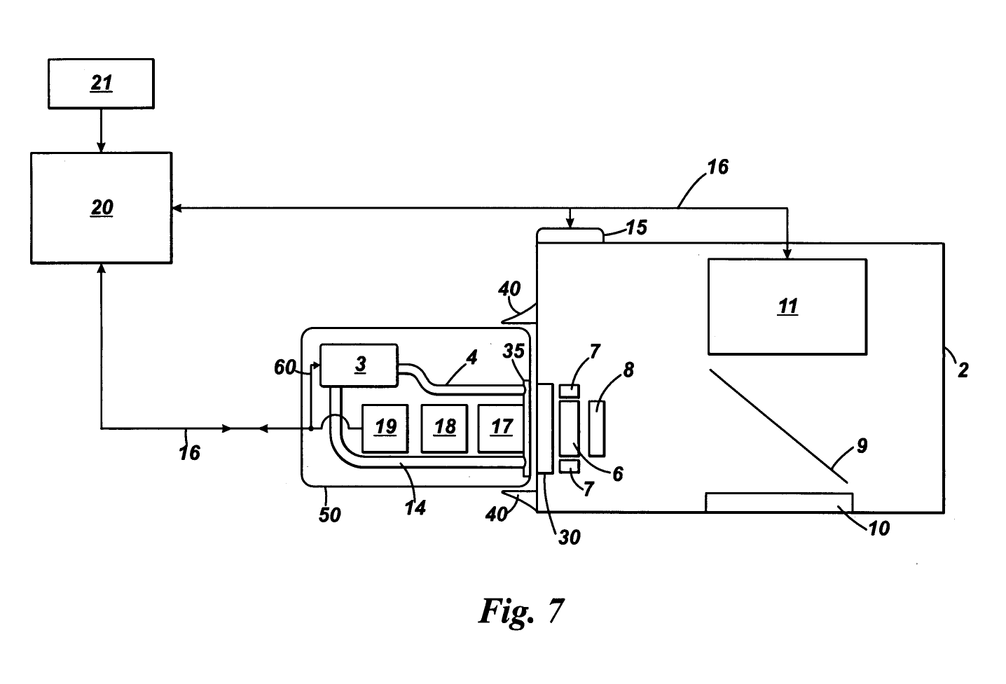

FIG. 7 illustrates apparatus including a hand-held intra-oral probe and remote computing components.

In the figures like items are assigned like reference symbols for consistency.

FIG. 1 illustrates schematically an apparatus 1 for imaging a tooth.

The apparatus includes an intra-oral hand-held probe 2 dimensioned to be held in the hand of a user and at least partly inserted into the mouth of a patient immediately adjacent a target tooth.

The apparatus includes an infra-red camera 19 and an illumination light source 3 each remote from the probe 2 and each in optical communication with the probe 2 via a respective one of two aligned optical fibre bundles (4, 5). The illumination light means is arranged to generate light of a broadband spectral content covering visible light and near-infra-red light (e.g. including wavelengths in a range from 300 nm to 2500 nm or more, preferably inclusive of all such wavelengths), and to output generated light to an input end 4A of a first of the two aligned optical fibre bundles 4 for transmission therealong to an output end 4B thereof housed in the probe 2 for output from the probe in illuminating a target tooth 25.

Preferably, the illumination light source 3 and the optical fibre bundles 4,5 are arranged to deliver full-field illumination to the target tooth 25. The infra-red camera 19 is likewise arranged to detect or capture full-field images. That is, the apparatus works on a full-field principle in which a whole area of the target tooth 25 is illuminated and a corresponding image captured, rather than scanning a point-like illumination across the surface of the tooth.

The infra-red camera 19 contains an infra-red pixel sensor array (not shown) responsive to infra-red radiation incident upon in to generate one or more image pixel values, and to output the pixel value(s) for use. A second of the two aligned optical fibre bundles 5 places the probe 2 in optical communication with an infra-red camera 19, and possesses an optical input end 5B housed within the probe 2 and arranged to receive light returned from a target tooth 25, and to guide the returned light to an optical output end 5A thereof for receipt by the infra-red pixel sensor array of the infra-red camera.

Immediately adjacent the optical input end 5B of the second aligned optical fibre bundle 5, and housed within the probe, is one or more input image collecting optical element 6 (e.g. one or more lenses) arranged in optical communication with the optical input end of the second aligned optical fibre bundle. The input image collecting optical element possesses an optical axis co-linear with that of the optical input end of the second aligned optical fibre bundle, and is adapted and arranged, or controllable, to gather light received thereby and to direct the gathered light into the optical input end of the second aligned optical fibre bundle. The image-collecting optical element 6 is arranged and controllable to form a focused optical image upon the exposed terminal optical input end 5B of the second aligned optical fibre bundle 5 using returned infra-red light from the target tooth 25. In this way, a focused image of the target tooth 25 may be transmitted along the second aligned optical fibre bundle 5 to the infra-red camera 19. In effect, the second aligned optical fibre bundle 5 serves to optically place the infra-red pixel sensor array of the infra-red camera 19 effectively or notionally within the intra-oral hand-held probe 2, without being physically present there. That is to say, the flat surface collectively formed by the plurality of closely-packed optical fibre ends defining the optical input end 5B of the second aligned optical fibre bundle, acts as a proxy imaging surface.

Indeed, in alternative examples of the invention, such as is schematically illustrated in FIG. 7, the second aligned optical fibre bundle 5 may be dispensed with and a detachably attachable unit 50 may be provided containing an infra-red camera 19, and additional optical elements e.g. a filter unit 18, imaging optical element(s) 17, illumination light source 3, and aligned optical fibre bundle 4 for guiding light generated by the illumination means outwardly of the detachable unit 50. The detachable unit 50 may include an optical window 35 with which the imaging optical element(s) 17, the filter unit 18, the infra-red camera 19, the illumination light source 3 and the first aligned optical fibre bundle 4 are in optical communication to enable light from the illumination light source 3 to exit the detachable unit 50, and to allow returned light to pass into the detachable unit 50 through the optical elements, the filter unit, and to the infra-red camera therein. In this alternative example, a second optical window 30 is provided at a surface of the hand-held probe 2 positioned relative to a plurality of positioning lugs 40 arranged and dimensioned to intimately receive the detachable unit at that part thereof containing the input/output window 35 thereof. The lugs 40 may be arranged to enable a snap-fit connection or a screw-fit connection or any other suitable connection as may be desirable. The dimensioning of the relevant receivable part of the detachable unit 50 and the receiving lugs 40 is such as to align, in register, the input/output window 35 of a detachable unit 50 with the input/output window 30 of the hand-held probe 2. This enables optical communication between the optical elements within the detachable probe and associated optical elements within the hand-held probe. Reference numerals employed in FIG. 7 identify the same articles as described with reference to FIG. 1 herein.

Adjacent the input image collecting optical element 6, and in optical communication therewith, is an input optical linear polarising filter 8 arranged to receive light returned from an illuminated target tooth 25 and to transmit substantially only that part of the received light which is linearly polarised light according to the polarisation axis defined by the filter, for transmission through the input image collecting optical element 6 and along the second aligned optical fibre bundle 5 for receipt by the infra-red camera 19.

The first aligned optical fibre bundle 4 comprises a group of optically aligned (i.e. with parallel optical axes) optical fibres which collectively envelop the second aligned optical fibre bundle 5 thereby forming therearound, in cross-section, a ring or annulus of optical fibres.

The optical input end 4A of the first aligned optical fibre bundle adjacent the illumination light source 3, is spaced from the second aligned optical fibre bundle 5 by a diversion or bifurcation of the optical fibres of the first aligned bundle from those of the second aligned optical fibre bundle, at a location between the probe 2 and the infra-red camera 19. This permits the illumination light source 3 to be located at any convenient location separated from the optical output end 5A of the second aligned optical fibre bundle 5 and any elements of the apparatus following that (e.g. IR camera 19).

The optical output end 4B of each optical fibre of the first aligned optical fibre bundle 4, housed within the probe 2, is in immediate optical communication with an output optical linear polarising filter 7 arranged to receive light guided from the illumination light source 3 along the first aligned fibre bundle 4, and to transmit light linearly polarised according to the linear polarisation axis of the output optical linear polarising filter for illuminating a target tooth 25.

The linear polarisation axis of the output optical linear polarising filter 7 is aligned to be perpendicular to the axis of linear polarisation of the input optical linear polarising filter 8. This reduces the content, within light returned to the probe from an illuminated tooth 25, of light resulting from specular reflection from a surface of the illuminated tooth. Polarised light transmitted by the output optical linear polarising filter, specularly reflected from a tooth surface, tends to preserve its initial state of polarisation. Consequently, such preserved polarisation prevents transmission of such light through the input optical linear polarising filter thereby at least to some extend eliminating specularly reflected light which has not undergone de-polarisation by scattering within the material (e.g. enamel) of the target tooth.

A beam-splitting mirror 9 is arranged in optical communication with both the optical output end 4B of the first aligned optical fibre bundle and the optical input end 5B of the second aligned optical fibre bundle so as to receive light output by the output linear optical polarising filter 7 and to reflect such received light through an angle (e.g. 90°) to direct the light outwardly of the probe 2 via a transparent protective window 10 of the probe. The beam-splitting mirror 9 is also arranged to receive via the protective window 10 light returned from the target tooth 25 and to reflect a portion of the returned light towards the input optical linear polariser 8 for subsequent transmission to the infra-red camera 19. The beam-splitting mirror 9 is arranged to transmit at least a portion of the visible light (e.g. between 25% and 50%) returned from the tooth 25 such that the light transmitted thereby is received by a reference imaging camera 11 responsive thereto to form an image of the target tooth using optically visible light.

The reference imaging camera preferably comprises a colour camera including a pixel-sensor imaging array 12 responsive to visible light to generate image pixel values for use in generating an image. The reference imaging camera includes an optical filter 14 located between the beam-splitting mirror 9 and the pixel-sensor array 12 and arranged to transmit wavelengths of light corresponding to visible light for receipt by the pixel-sensor array. Located between the filter 14 and the pixel-sensor array 12 is an imaging optical element 13, or optical train, comprising lenses or the like arranged to form an image on the pixel-sensor array 12 using light transmitted thereto by the filter 14. The imaging optical element 13 is preferably adapted for forming images over the whole visible light spectrum and the pixel-sensor array 12 is preferably a colour pixel-sensor array adapted to form colour images.

A control panel 15 is arranged upon the probe, and comprises one or more control buttons, or other manually operable control user-interfaces (not shown), enabling the user to control functions and operations of the probe by hand.

The control panel may be arranged to control any one or more of: the capturing of images by the reference camera 11 (e.g. act as a “shoot” button); the capturing of images by the IR camera unit 19; the intensity of illuminating light produced by the illumination light source 3; the filtering state of the filter unit 18; the focussing of the image collecting optics 6; the optical magnification provided by (e.g. zoom) the image collecting optics 6.

A remote imaging optical element(s) 17 and a filter unit 18 are arranged in successive common optical communication with, and between, the optical output end 5A of the second aligned optical fibre bundle 5, distal the probe 2, and the infra-red imaging camera 19.

The remote imaging optical element(s) 17 comprises one or more lens elements, or the like, arranged to form from light received thereby from the second aligned optical fibre bundle 5 an image of the target tooth 25 from which the light in question was returned.

The filter unit 18 is arranged to receive light output by the remote imaging optical element(s) 17 and to transmit, according to the optical transmission characteristics of the filter unit, portions of received light to the infra-red pixel sensor array of the infra-red camera 19. The remote imaging optical element(s) 17 may be arranged or controllable for form a focused image on the infra-red pixel sensor array via the filtering optics of the filter unit 18. The filter unit may comprise a liquid-crystal variable optical filter element possessing a selectively variable optical transmission spectral characteristic and being controllable to selectively transmit optical radiation only within any one of a number of selected wavelength bandwidths (e.g. infra-red radiation). Alternatively, the filter unit 18 may comprise a filter wheel including a plurality of separate dedicated filter elements (e.g. glass filters of the like) each possessing a fixed spectral transmission characteristic and each being selectively movable into the path of light output by the imaging optics 17 thereby to filter that light for subsequent transmission to the infra-red camera 19.

The filtering unit is arranged to selectively filter light received thereby according to any selected one of three pass-band transmission spectral characteristics with each pass-band preferably centred upon a respective desired wavelength value (e.g. a value selected from: 1090 nm, 1440 nm, 1610 nm).

A first pass band of the filtering unit may be a pass band which extends from 1300 nm to 1550 nm, or from 1400 nm to 1500 nm, and may be centred on 1440 nm. A second pass band may extend from 1550 nm to 1800 nm, or from 1550 nm to 1650 nm, and may be centred on 1610 nm. A reference pass band of the filtering unit may be a pass band which extends from 1000 nm to 1150 nm, or from 1050 nm to 1130 nm, and may be centred upon 1090 nm. A third pass band of the filtering unit may be a pass band which extends from 1850 nm to 1970 nm, or from 1880 nm to 1940 nm, and may be centred upon 1910 nm. The pass band width of any one or more, or each, of the filter pass bands is preferably from 10 nm to 15 nm in extent. However, the pass band width in question may be up to 60 nm in extent, or thereabouts. The pass band width in question may be any size less than 60 nm and preferably wholly falls within a range of wavelengths which is 60 nm in extent and is centred upon a value selected from: 1090 nm, 1440 nm, 1610 nm.

Accordingly, operation of the filtering unit enables the infra-red camera to generate image pixel values representative of a respective one of three different images formed using light of a corresponding one of three different infra-red wavelengths. Reflectance values may be calculated from two of the three images using pixel values of the third image to normalise the reflectance values. Reflectance values may be used to calculate a measure of lesion (e.g. a carries score) a given imaged part of the tooth common to all three images.

The apparatus further includes a computer 20, such as a personal computer or the like, arranged to receive image pixel values representative of images formed upon the infra-red pixel sensor array of the infra-red camera 19, and to process those pixel values as discussed below.

The illumination source 3, the control panel 15 of the probe 2, and the reference imaging camera 11 of the probe 2, are each also in communication with the computer 20 via a data transmission link 16 via which control data and image data are passed between the elements of the apparatus interconnected thereby.

A control foot switch 21 is connected in operable communication with the computer 20 and is arranged to control any one or more of: the capturing of images by the reference camera 11 (e.g. act as a “shoot” button); the capturing of images by the IR camera unit 19; the intensity of illuminating light produced by the illumination light source 3; the filtering state of the filter unit 18; the focussing of the image collecting optics 6; the optical magnification provided by (e.g. zoom) the image collecting optics 6. The implementation of these functions via the control foot switch enables a user to control the operation of the probe 2 without having to manually operate elements of the control panel 15 when it is desirable not to move or shake the probe—such as when “shooting” images in use or the like.

The computer includes image processing means (e.g. implemented using software) arranged to receive pixel image values from the infra-red camera and to produce images therefrom. The image processing means is arranged to co-register separately acquired images of a common target tooth 25, each obtained using a different selected respective filter of the filter unit, thereby to associate a given image pixel of the any one co-registered image with a respective image pixel of any other co-registered image representing the same part of the imaged subject. This a reflectance spectrum or profile to be generated in respect of each such co-registered pixel value, thereby providing a hyper-spectral image data set to be formed. The reference image pixel values generated by the reference camera 11 are also received by the computer (via data transmission line 16) and are co-registered with images containing the same target tooth 25 via the IR camera 19 at different IR wavelengths. Thus, a “visible light” reference image may be provided representing the imaged tooth as would be perceived by the user regarding the tooth, together with two or three corresponding (and co-registered) images of the target tooth taken using one of two or three different infra-red (IR) wavelengths of light. The image processing means preferably permits the user to select upon the reference image of the tooth a pixel representing a given location on the tooth, and in response to such selection may present and one or more of: the pixel values of the corresponding IR images co-registered with the reference image corresponding to the selected location on the tooth; reflectance values of the selected location in respect of the wavelengths of light employed to generate the IR images; a measure of lesion present in the tooth at the selected region of the tooth; a carries score in respect of the selected region of the tooth.

In one example, the computer includes data processing means is arranged, in respect of a given part of the imaged tooth, to use one or more image pixel values of a first IR image (taken using a first IR wavelength or pass-band) to calculate a first reflectance value associated with the part, and to use one or more image pixel values of a second IR image (taken using a second IR wavelength or pass-band different from the first) to calculate a second reflectance value associated with the same tooth part. The data processing means of the computer determines from the first and second reflectance values a measure of the degree of enamel lesion (Sₑ) and/or dentin lesion (S_{d}) present in the common tooth part. An example is given below.

The data processing means may be arranged to use this measure of the degree of enamel lesion (Sₑ) and the measure of the degree of dentin lesion (S_{d}) to calculate a measure (S_{caries}) of the degree of caries present in the part. An example is given below.

Well defined signatures have been observed in reflectance (R) spectra from teeth at NIR wavelengths. Reflectance (R) above 1400 nm tend to be higher for the decayed areas and in particular at 1610 nm. NIR reflectance dips (i.e. NIR absorption) are pronounced by dentin lesion, and especially at 1440 nm.

A first pass band of the filtering unit may be a pass band which extends from 1300 nm to 1550 nm, or from 1400 nm to 1500 nm, and may be centred on 1440 nm. A second pass band may extend from 1550 nm to 1800 nm, or from 1550 nm to 1650 nm, and may be centred on 1610 nm. A reference pass band of the filtering unit may be a pass band which extends from 1000 nm to 1150 nm, or from 1050 nm to 1130 nm, and may be centred upon 1090 nm. A third pass band of the filtering unit may be a pass band which extends from 1850 nm to 1970 nm, or from 1880 nm to 1940 nm, and may be centred upon 1910 nm. The pass band width of any one or more, or each, of the filter pass bands is preferably from 10 nm to 15 nm in extent. However, the pass band width in question may be up to 60 nm in extent, or thereabouts. The pass band width in question may be any size less than 60 nm and preferably wholly falls within a range of wavelengths which is 60 nm in extent and is centred upon a value selected from: 1090 nm, 1440 nm, 1610 nm, 1910 nm.

The computer 20 is arranged to process pixel values (correlated to spectral intensity) at each IR image pixel by normalising it to (e.g. dividing it by) the corresponding (co-registered) image pixel value associated with a reference reflectance (R) e.g. obtained at the wavelength with the highest reflectance (least extinction) e.g. 1090 nm. The degree of enamel, Sₑ, and dentin, S_{d}, lesions are to be calculated by the computer as follows:

$${S}_{e} = {S}_{e}^{( 1 )} = \frac{R ( 1610 nm )}{R ( 1090 nm )} or {S}_{e} = {S}_{e}^{( 1 )} = \frac{R ( 1440 nm ) - R ( 1910 nm )}{R ( 1090 nm )}$$

$${S}_{d} = \frac{R ( 1610 nm ) - R ( 1440 nm )}{R ( 1090 nm )}$$

As can be seen from FIG. 3, a rise in reflectance occurs at around 1900 nm and is associated with the scattering of infra-red light from demineralised tooth enamel. In demineralised enamel, light is scattered more than in sound enamel. Scattered intensity is typically a function of wavelength, that is to say, the amount of light scattered tends to drop in inverse proportion to wavelength increases. In a non-absorbing medium the wavelength dependence becomes apparent when comparing the reflectance intensities of two spectral regions. In such a case, demineralised enamel presents a scattering characteristic in the spectral reflectance thereof. The degree of enamel lesion Sₑ⁽²⁾ is suitable for use to enhance the effect of scattering of light and to separate the influence of absorption by water. Two spectral dips occur in the spectrum of FIG. 3 at about 1440 nm and 1910 nm, and a comparison of the reflectance intensities at these wavelengths is employed. By looking at the intensity of these two dips, when scattering dominates over water absorption, the dips may become less pronounced, but the wavelength dependence introduced by scattering will become stronger. In this way, the relative rise in reflectance at 1910 nm is principally due to enamel demineralisation, and the relationship between the two spectral intensities employed in the measure Sₑ⁽²⁾ is used to unveil this feature.

The computer is arranged to calculate the caries score, S_{caries}, as follows:

$${S}_{caries} = p ( \frac{{S}_{e} - {K}_{e}}{{N}_{e}} ) + ( 1 - p ) ( 1 + \frac{{S}_{d} - {K}_{d}}{{N}_{d}} )$$

Here, Kₓ and Nₓ are the enamel (x:e) and dentin (x:d) score calibration offset and normalisation factor, respectively. In addition, p=1 if

$$( 1 + \frac{{S}_{d} - {K}_{d}}{{N}_{d}} ) ≺ {S}_{dth}$$

where S_{dth} represents the dentin lesion threshold, otherwise p=0.

An example of another implementation of the invention follows using sample target teeth.

Twelve extracted human teeth (premolars and molars) with natural lesions of various degrees were acquired. Soft tissues were removed from the collected teeth and these were thoroughly cleaned. Each tooth was stored in a separate container with distilled water and 0.5% thymol to keep them hydrated and sterile and therefore free from bacteria. Note that the teeth were kept for at least 2 hours in the bottle containers before any (hyperspectral) images were taken to get the measurements closer to the natural hydration conditions. The excess of water on the occlusal surfaces was however gently wiped off using cotton.

A near-infrared (NIR) hyperspectral camera was used to capture the spectral reflectance from the samples. The instrument images a line of vision at a time and diffracts the light onto a 2-dimensional pixel-sensor array by means of a diffraction grating. A complete stack of spectral images (spectral data cube) is obtained by translating the sample at constant speed and line-imaging synchronously. The spectral analysis range was from 1000 nm to 2500 nm with a spectral resolution of 10 nm. FIG. 1 shows an image of the system set-up. Note that a two-side illumination using halogen lamps was configured to reduce the effect of shadowing.

Acquired reflectance data, a dark current measurement associated with the data acquired (for noise subtraction), reflectance spectra of a reference object and its associated dark current measurement were used as follows to calibrate spectral reflectance data, this calculation being performed for each image pixel value:

$$R ( λ ) = \frac{{R}_{r} ( λ ) - {D}_{r}}{{W}_{ref} ( λ ) - {D}_{w}} {W}_{spec} ( λ ) \qquad eq . ( 1 )$$

Here R(λ), Rᵣ(λ) and W_{ref}(λ) are the calibrated, raw and white reference measurements at wavelength λ, respectively. W_{spec}(λ) corresponds to a white reference reflectance at wavelength λ. In addition, Dᵣ and D_{W} are the dark current noise measurements obtained for the raw white reference reflectance data.

Histological information was obtained for all samples after obtaining the NIR hyperspectral images. The teeth were grounded along the transversal plane to their surface. Sub-millimetres grounding steps were performed and a photograph was taken after each step. The histology scoring was done for the slide showing the most representative lesion for each tooth. The score was given based on the criteria shown in Table I.

TABLE I
Histology scoring criteria.

| Score | Code: Lesion depth |
|---|---|
| 0 | S: Sound |
| 1 | E1: ⅓ enamel |
| 2 | E2: ⅔ enamel |
| 3 | EDJ: enamel-dentin junction |
| 4 | D1: ⅓ dentin |
| 5 | D2: ⅔ dentin |
| 6 | D3: to the pulp |

As an example, a selection of the spectral images obtained from an occlusal tooth surface is shown in FIG. 2 at the wavelengths indicated. It is possible to see that the reflectance intensity drops at higher wavelengths.

A typical reflectance spectrum for sound material, white spot material (enamel lesion) and a dentin lesion material is shown in FIG. 3. Well defined signatures can be observed among the three cases. For instance, reflectance above 1400 nm is clearly higher for the decayed areas and in particular at 1610 nm. However, the absorption dips are further pronounced for the case of dentin lesion, and specially at 1440 nm.

The spectral intensity at each pixel was normalised to the reflectance obtained at 1090 nm since this the wavelength with the highest reflectance (least extinction). The degree of enamel, Sₑ, and dentin, S_{d}, lesions were therefore calculated as follows:

$$\begin{matrix}{S}_{e} = \frac{R ( 1610 nm )}{R ( 1090 )} & eq . ( 2 ) \\ {S}_{d} = \frac{R ( 1610 nm ) - R ( 1440 nm )}{R ( 1090 )} & eq . ( 3 )\end{matrix}$$

A caries score, S_{caries}, was calculated as a combination of Sₑ and S_{d} and was designed to account for the deepest lesion observed by the NIR spectrum as follows:

$${S}_{caries} = p ( \frac{{S}_{e} - {K}_{e}}{{N}_{e}} ) + ( 1 - p ) ( 1 + \frac{{S}_{d} - {K}_{d}}{{N}_{d}} ) \qquad eq . ( 4 )$$

Here, Kₓ and Nₓ are the enamel (x:e) and dentin (x:d) score calibration offset and normalisation factor, respectively. In addition, p=1 if

$$( 1 + \frac{{S}_{d} - {K}_{d}}{{N}_{d}} ) ≺ {S}_{dth}$$

where S_{dth} represents the dentin lesion threshold, otherwise p=0.

Outliers and noise introduced by specular reflections were removed by limiting the values of the numerators in Equation 4 to the range 0<(Sₑ−Kₑ)<Mₑ and 0<(S_{d}−K_{d})<M_{d}; here Mₑ and M_{d} denote the upper limits. Values outside these limits were set to zero.

In order to fix the range of S_{caries} from 0 to 2, the normalization factors in Equation 4 were expressed as Nₑ=Mₑ/S_{dth} and N_{d}=M_{d}. Therefore for values in the range of 0<S_{caries}≦S_{dth} the score indicates an enamel lesion and for S_{caries}>S_{dth} the score indicates a dentin lesion. Note that sound areas have a value of S_{caries}=0.

The calibration values for the equations above were obtained empirically. For our case, results were best described with S_{dth}=1.1, Kₑ=0.14, K_{d}=0.05, Mₑ=0.35, and Mₑ=0.15.

Twelve teeth with different lesion degrees were imaged and processed following the method described above. As an example, coded S_{caries} maps for four teeth are shown in FIG. 4. The associated pictures and the selected histological sections chosen are also shown.

Note that the extension of the lesion is not evident from the pictures in FIG. 4 (which rely on visible wavelengths). It is possible to see however that the caries score maps clearly depict the lesion spatial distribution. This is due to the longer light penetration of NIR wavelengths through enamel. In addition, the depth of the lesions can be confirmed from the histological sections. The arrows pointing toward the colour pictures of FIG. 4 indicate the point of view of the histological section, which is indicated by the straight line traversing a given picture of a tooth.

For the examples presented in FIG. 4, lesions in Tooth A rest within the enamel, having S_{caries}<1.1, whereas the lesions in Teeth B, C and D reach the dentin, having S_{caries}>1.1. These observations can be confirmed with the histological sections which are scored as EDJ for Tooth A and D2 for Teeth B, C and D. The black points highlighted in each carries score map image (by an arrow) correspond to the maximum scores found within the region corresponding to the histological section and the average value is indicated by the arrow.

Hidden lesions, such as the one in Tooth D, are of particular interest since visual inspection does not reveal them easily and they could be left untreated increasing the risk of tooth loss. It is clear from the histology section that the damage has reached the dentin for this case and this is adequately indicated by values of S_{caries}>1.1 around the decayed region.

Detection of caries in pits and fissures is of great interest among the dental practitioners since demineralisation commonly starts in these sites and the detection of them is not always obvious, especially in the presence of stain. The decay in the fissure pattern of Tooth A can be easily discriminated in the S_{caries} map; the demineralised part of the “U”-shaped fissure of this tooth is well described and confirmed with the histological section. Enamel demineralisation in the fissure pattern of the remaining teeth shown in FIG. 4 are also depicted by their corresponding S_{caries} map but it is the deepest tooth lesion the one considered for our statistical analysis below.

The NIR images are to some extent affected by specular reflection, especially around the edges and the crests of the teeth where reflections are expected to be strong. These reflections act as a noise factor, especially for the calculation of Sₑ in Equation 2 above. Note that the stain and pigmentation in all teeth did not show a significant interference with the measurements.

The NIR image processing algorithm discriminates well between sound enamel, enamel lesions and dentin lesions.

A region from each of the S_{caries} maps corresponding to the selected histological section was obtained. A histogram of the values obtained across this region was calculated and the value corresponding to the highest bin with more than five pixels was extracted. This reduces or removes false maxima that could be caused by specular reflections. The average of the values within the extracted bin was used as an indication of the maximum S_{caries} score in the region and was compared to the histology score.

FIG. 5 shows a correlation graph between the two scores and a Pearson correlation 0.89 significant at a level p<0.01 was found. In addition, a sensitivity of 75% and a specificity of 87.5% for enamel lesions and a sensitivity of 87.5% and a specificity of 100% for dentine lesions were found using the NIR spectral imaging method.

Detecting early stages of tooth decay is advantageous as it is reversible and the progression to a stage where restorative intervention is required might therefore be avoided. Screening early lesions in occlusal pits and fissures is advantageous since these regions have a higher susceptibility to bacterial deposition and therefore deminaralisation. Visual inspection and radiography are commonly used in the clinic to perform this task; however, such methods lack the sensitivity needed to detect early stages of the disease and also the ability to quantify its progression.

Hyperspectral imaging is a powerful method used to interrogate the spectral characteristics of samples in a two-dimensional space. This is now found to be of particular use when studying teeth due to their inherent heterogeneous occlusal geometry and associated lesion distribution. This method may be employed according to the present invention which demonstrates the ability of NIR spectral imaging to quantify caries lesions from occlusal surfaces. A light reflectance configuration, preferably back-scattering of light, is preferably employed in the invention since uniform illumination of the tooth is easily achieved. Imaging with NIR wavelengths means that stain no longer represents a strong confounding factor when detecting tooth demineralization.

FIG. 6 shows an example of the reflectance obtained at a wavelength of 1250 nm for three heavily stained teeth. It is possible to observe that the absorption of light by stain is minimal and confirms previous reported observations employing NIR wavelengths.

Note that the spectral intensity dips observed in the reflectance spectra shown in FIG. 3 correspond to the absorption peaks of water. In addition, the expected raise in light scattering caused by white spot lesions can be observed in the spectra as a background intensity across all wavelengths. The results obtained for the different lesions suggest that, as the cavity reaches the dentin, the lesion size increases and the amount of water within increases too. For early enamel demineralization, the effect is rather observed as an augmented light scattered intensity at the surface due to the porous structure of the lesion. These physical effects may be used, according to the invention, as a mechanism to quantify the extension of tooth decay. Use of the reflectance at 1440 nm and 1610 nm, such as presented in Equation 4, is suitable (though other wavelengths may be considered) since these wavelengths appear to be most affected by water absorption and scattering as shown in FIG. 3 for enamel and dentin lesions. Sound regions of the teeth show a reduced reflectance at wavelengths above 1450 nm; this may be caused by an increase in the absorption of light by hydroxyapatite and/or collagen; decayed areas have a reduced amount of mineral and/or organic material and this may explain the observed higher reflectance at such wavelengths.

Although special attention may be paid in pixel data processing algorithms discussed above, to remove the influence of specular reflections from reflectance data, measured pixel data values may still be affected by this source of noise, in particular at the edges and crests of the tooth present strong reflections are expected.

In another example, the filtering unit is arranged to selectively filter light received thereby according to any selected one of four pass-band transmission spectral characteristics with each pass-band preferably centred upon a respective desired wavelength value (e.g. a value selected from: 1090 nm, 1440 nm, 1610 nm, 1910 nm).

The above examples are intended for illustration and are not intended to be limiting. Variants and modifications to the examples, such as would be readily apparent to the skilled person, may be made without departing from the scope of the invention.

The following statements provide general expressions of the disclosure herein.

A. Apparatus for imaging a tooth including:

illumination means arranged to generate first infra-red light with a first wavelength having a value within a range of values corresponding to an infra-red spectral absorption band of water, to generate second infra-red light with a second wavelength having a value within a range of values corresponding to an infra-red spectral reflection band characteristic of scattering from demineralised tooth enamel, and for illuminating a tooth therewith;

image data acquisition means arranged for receiving infra-red light originating from the illumination means and returned from an illuminated tooth, and including infra-red pixel sensor means responsive to said returned infra-red light to generate image pixel values for a first image of the illuminated tooth using first infra-red light and not second infra-red light and to generate image pixel values for a second image of the illuminated tooth using second infra-red light and not first infra-red light, and to provide such image pixel values for use.

B. Apparatus according to any preceding statement in which the image data acquisition means includes optical input means via which the apparatus is arranged to receive infra-red light returned from an illuminated tooth in a direction substantially parallel with, or subtending an acute angle with respect to, a direction of illumination by the illumination means.
C. Apparatus according to any preceding statement in which the illumination means comprises optical output means with an optical axis along which the apparatus is arranged to output said infrared light to illuminate a tooth, and the image data acquisition means includes optical input means comprising an optical axis along which the apparatus is arranged to receive infrared light returned from an illuminated tooth and which is substantially parallel to, or subtends an acute angle with respect to, the optical axis of the illumination means.
D. Apparatus according to any preceding statement in which the image data acquisition means includes camera means including a pixel sensor array responsive to visible light returned from an illuminated tooth to form one or more image pixel values representing an image of at least a part of the tooth.
E. Apparatus according to any preceding statement including infra-red optical filter means selectively operable in a first state to transmit infra-red light originating from the illumination means having said first wavelength and to substantially prevent transmission therethrough of infra-red light having said second wavelength, and in a second state to transmit infra-red light originating from the illumination means having said second wavelength and to substantially prevent transmission therethrough of infra-red light having said first wavelength.
F. Apparatus according to statement E in which the infra-red optical filter means is arranged in optical communication with the infra-red pixel sensor means to filter infra-red light directed to the infra-red pixel sensor means by the image data acquisition means.
G. Apparatus according to statement E in which the illumination means comprises light-source means operable to generate light including said first and second wavelengths, wherein the infra-red optical filter means is arranged in optical communication with the light-source means to filter light generated by the light-source means for illuminating a tooth with infra-red radiation transmitted by the infra-red optical filter means.
H. Apparatus according to any preceding statement in which the illumination means comprises light-source means operable to generate light including said first and second wavelengths, and optical output means remotely in optical communication with the light-source means via output optical waveguide means and arranged to output from the apparatus light generated by the light-source means to illuminate a tooth.
I. Apparatus according to any preceding statement including optical input means remotely in optical communication with the infra-red pixel sensor means via input optical waveguide means and arranged to receive infra-red light returned from an illuminated tooth and to direct the returned infra-red light to the remote infra-red pixel sensor means for sensing thereby.
J. Apparatus according to statement H and statement I including a remote intra-oral probe comprising the optical input means and the optical output means.
K. Apparatus according to statement J in which the input optical waveguide means comprises one or more optical fibres which collectively define an aligned optical fibre bundle.
L. Apparatus according to statement J or K in which the output optical waveguide means comprises one or more optical fibres collectively defining an aligned optical bundle.
M. Apparatus according to statements J to L in which at least a terminal end of the output optical waveguide means is adjacent the optical input means.
N. Apparatus according to statement M in which the terminal end of the output optical waveguide comprises a bundle of optical fibres the ends of which form a ring circumscribing the output optical waveguide.
O. Apparatus according to any preceding statement in which the illumination means comprises first optical polarizer means for polarizing according to a first polarization axis infra-red radiation generated by the illumination means, and the image data acquisition means comprises second optical polarizer means for polarizing according to a second polarization axis transverse to the first polarization axis infra-red radiation received thereby from an illuminated tooth.
P. Apparatus according to any preceding statement in which the image data acquisition means comprises focussing means arranged to form upon the infra-red pixel sensor means a real optical image using infra-red light received by the image data acquisition means from an illuminated tooth.
Q. Apparatus according to statement P when dependent upon statement E and statement I in which the optical filter means, the focussing means and infra-red pixel sensor means are each in mutual optical communication and remotely in optical communication with the optical input means via said input optical waveguide means.
R. Apparatus according to any preceding statement including image processing means arranged to receive said pixel image values for producing one or more of said'first and second images therefrom.
S. Apparatus according to statement R in which the image processing means is arranged to co-register a said first image and a said second image in respect of a common imaged subject, thereby to associate a given image pixel of the first image with a respective image pixel of the second image representing the same part of the imaged subject.
T. Apparatus according to any preceding statement including data processing means arranged in respect of a given part of the imaged subject to use one or more image pixel values of the first image to calculate a first reflectance value associated with the part, and to use one or more image pixel values of the second image to calculate a second reflectance value associated with the part, and to determine from the first and second reflectance values a measure of the degree of enamel lesion (Sₑ) and/or dentin lesion (S_{d}) present in the part.
U. Apparatus according to statement T in which the data processing means is arranged to use said measure of the degree of enamel lesion (Sₑ) and said measure of the degree of dentin lesion (S_{d}) to calculate a measure (S_{caries}) of the degree of caries present in the part.
V. Apparatus according to any preceding statement in which the infra-red pixel sensor means is responsive to said returned infra-red light to generate image pixel values for a reference image of the illuminated tooth using reference infra-red light and not first infra-red light nor second infra-red light, and to provide such image pixel values for use.
W. Apparatus according to statements E and V at least in which the infra-red optical filter means is selectively operable in a third state to transmit infra-red light originating from the illumination means having said reference wavelength and to substantially prevent transmission therethrough of infra-red light having any of said first wavelength and said second wavelength.
X. Apparatus according to statement T and statement V or statement W in which the data processor means is arranged to use one or more image pixel values of the reference image to calculate a reference reflectance value associated with the part, and to determine the measure of the degree of enamel lesion (Sₑ) and/or dentin lesion (S_{d}) present in the part using the reference reflectance value.
Y. Apparatus according to any preceding statement in which the first wavelength value is between 1300 nm and 1550 nm, and the second wavelength value is between 1550 nm and 1800 nm.
Z. Apparatus according to statement Y in which the first wavelength value is between 1400 nm and 1500 nm, such as 1440 nm, and the second wavelength value is between 1550 nm and 1650 nm, such as 1610 nm.
ZA. A method for imaging a tooth including:

generating first infra-red light with a first wavelength having a value within a range of values corresponding to an infra-red spectral absorption band of water, generating second infra-red light with a second wavelength having a value within a range of values corresponding to an infra-red spectral reflection band characteristic of scattering from demineralised tooth enamel, and illuminating a tooth therewith;

receiving at infra-red pixel sensor means first and second infra-red light returned from an illuminated tooth and therewith generating image pixel values for a first image of the illuminated tooth using first infra-red light and not second infra-red light and generating image pixel values for a second image of the illuminated tooth using second infra-red light and not first infra-red light, and providing such image pixel values for use.

ZB. A method according to statement ZA including receiving infra-red light returned from an illuminated tooth in a direction substantially parallel with, or subtending an acute angle with respect to, a direction of said illumination.
ZC. A method according to any of statements ZA to ZB including providing optical output means comprising an optical axis and therealong outputting said infrared light to illuminate a tooth, and providing optical input means comprising an optical axis and therealong receiving infrared light returned from an illuminated tooth for subsequent receipt at the infra-red pixel sensor means wherein the said optical axes are substantially parallel, or subtend an acute angle with respect to each other.
ZD. A method according to any of statements ZA to ZC including forming an image representing at least a part of the illuminated tooth using visible light returned therefrom.
ZE. A method according to any of statements ZA to ZD including generating light for illuminating the tooth and in a first instance, filtering the light by transmitting through a filter means parts of said light having said first wavelength and substantially preventing transmission through the filter means of parts of said light having said second wavelength; and in a second instance, filtering the light by transmitting through the filter means parts of said light having said second wavelength and substantially preventing transmission through the filter means parts of said light having said first wavelength.
ZF. A method according to statement ZE including performing said filtering on light directed to the infra-red pixel sensor means.
ZG. A method according to statement ZE including performing said filtering on light for illuminating a tooth.
ZH. A method according to any of statements ZA to ZG including generating said light remotely from said tooth, guiding the generating light to the proximity of the tooth, and illuminating the tooth with the guided light.
ZI. A method according to any of statements ZA to ZH including guiding said returned infra-red light to a location remote from the point of receipt of the returned light and generating image pixel values using said returned, guided light at said remote location.
ZJ. A method according to any of statements ZA to ZI performed using an intra-oral probe.
ZK. A method according to any of statements ZA to ZJ including polarizing according to a first polarization axis infra-red radiation generated for illuminating a tooth, and polarizing according to a second polarization axis transverse to the first polarization axis infra-red radiation returned from the illuminated tooth.
ZL. A method according to any of statements ZA to ZK including forming upon an infra-red pixel sensor means a real optical image using said infra-red light returned from an illuminated tooth.
ZM. A method according to any of statements ZA to ZL including producing one or more of said first and second images from said returned light.
ZN. A method according to statement ZM including co-registering a said first image and a said second image in respect of a common imaged subject, thereby to associate a given image pixel of the first image with a respective image pixel of the second image representing the same part of the imaged subject.
ZO. A method according to any of statements ZA to ZN including generating image pixel values for a reference image of the illuminated tooth using reference infra-red light returned from the tooth and not first infra-red light nor second infra-red light, and providing such image pixel values for use.
ZP. A method according to statement ZO including, in respect of a given part of the imaged subject, calculating a first reflectance value R₁ associated with the part using one or more image pixel values of the first image, calculating a second reflectance value R₂ associated with the part using one or more image pixel values of the second image, calculating a reference reflectance value R_{ref} associated with the part using one or more image pixel values of the third image and determining from the first, second and reference reflectance values the values of the ratios R₁/R_{ref} and R₂/R_{ref} and providing the ratio values for use.
ZQ. A method according to statement ZP including calculating a value (R₂/R_{red}−R₁/R_{ref}) and providing the value for use.
ZR. A method according to any of statements ZA to ZQ including generating light for illuminating the tooth and in a third instance, filtering the light by transmitting through a filter means parts of said light having said reference wavelength and substantially preventing transmission through the filter means of parts of said light having any of said first wavelength and said second wavelength.
ZS. A method according to any of statements ZA to ZR in which the first wavelength value is between 1300 nm and 1550 nm, and the second wavelength value is between 1550 nm and 1800 nm.
ZT. A method according to statement ZS in which the first wavelength value is between 1400 nm and 1500 nm, such as 1440 nm, and the second wavelength value is between 1550 nm and 1650 nm, such as 1610 nm.
ZU. A computer programmed to implement the method of any of statements ZM to ZQ.
ZV. A computer program product comprising a computer-readable medium containing computer executable instructions which implement the method of any of statements ZM to ZQ when executed on a computer.
ZW. A computer program containing computer executable instructions which implement the method of any of statements ZM to ZQ when executed on a computer.
ZX. Apparatus according to any of statements A to Z including computer means programmed for use in implementing the method of any of statements ZA to ZT.
ZY. A computer program product comprising a computer-readable medium containing computer executable instructions for use in implementing the method of any of statements ZA to ZT when executed on apparatus according to statement ZX.
ZZ. A computer program containing computer executable instructions which implement the method of any of statements ZA to ZT when executed on apparatus according to statement ZX.

1. An apparatus for imaging a tooth including:
illumination means arranged to generate first infra-red light with a first wavelength having a value within a range of values corresponding to an infra-red spectral absorption band of water, to generate second infra-red light with a second wavelength having a value within a range of values corresponding to an infra-red spectral reflection band characteristic of scattering from demineralised tooth enamel, and for illuminating a tooth therewith;
image data acquisition means arranged for receiving infra-red light originating from the illumination means and returned from an illuminated tooth, and including infra-red pixel sensor means responsive to said returned infra-red light to generate image pixel values for a first image of the illuminated tooth using first infra-red light and not second infra-red light and to generate image pixel values for a second image of the illuminated tooth using second infra-red light and not first infra-red light, and to provide such image pixel values for use; and
data processing means arranged in respect of a given part of the imaged subject to use one or more image pixel values of the first image to calculate a first reflectance value associated with the part, and to use one or more image pixel values of the second image to calculate a second reflectance value associated with the part, and to determine from the first and second reflectance values a measure of the degree of enamel lesion (Sₑ) and/or dentin lesion (S_{d}) present in the part.

2. The apparatus according to claim 1 in which the image data acquisition means includes optical input means via which the apparatus is arranged to receive infra-red light returned from an illuminated tooth in a direction substantially parallel with, or subtending an acute angle with respect to, a direction of illumination by the illumination means.

3. Apparatus according to claim 1 in which the data processing means is arranged to determine from the first and second reflectance values a measure of the degree of enamel lesion (Sₑ) and a measure of the degree of dentin lesion (S_{d}) present in the part.

4. The apparatus according to claim 1 in which the data processing means is arranged to use said measure of the degree of enamel lesion (Sₑ) and said measure of the degree of dentin lesion (S_{d}) to calculate a measure (S_{caries}) of the degree of caries present in the part.

5. The apparatus according to claim 1 in which the image data acquisition means includes camera means including a pixel sensor array responsive to visible light returned from an illuminated tooth to form one or more image pixel values representing an image of at least a part of the tooth.

6. Apparatus according to claim 1 including infra-red optical filter means selectively operable in a first state to transmit infra-red light originating from the illumination means having said first wavelength and to substantially prevent transmission therethrough of infra-red light having said second wavelength, and in a second state to transmit infra-red light originating from the illumination means having said second wavelength and to substantially prevent transmission therethrough of infra-red light having said first wavelength.

7-8. (canceled)

9. The apparatus according to claim 1 wherein:
the illumination means comprises light-source means operable to generate light including said first and second wavelengths, and optical output means remotely in optical communication with the light-source means via output optical waveguide means and arranged to output from the apparatus light generated by the light-source means to illuminate a tooth;
the apparatus includes optical input means remotely in optical communication with the infra-red pixel sensor means via input optical waveguide means and arranged to receive infra-red light returned from an illuminated tooth and to direct the returned infra-red light to the remote infra-red pixel sensor means for sensing thereby; and
the apparatus includes a remote intra-oral probe comprising the optical input means and the optical output means.

10-11. (canceled)

12. The apparatus according to claim 9 in which the input optical waveguide means comprises one or more optical fibres which collectively define an aligned optical fibre bundle and/or the output optical waveguide means comprises one or more optical fibres collectively defining an aligned optical bundle.

13. (canceled)

14. The apparatus according to claim 12 in which at least a terminal end of the output optical waveguide means is adjacent the optical input means and in which the terminal end of the output optical waveguide comprises a bundle of optical fibres the ends of which form a ring circumscribing the output optical waveguide.

15. (canceled)

16. The apparatus according to claim 1 in which the illumination means comprises first optical polarizer means for polarizing according to a first polarization axis infra-red radiation generated by the illumination means, and the image data acquisition means comprises second optical polarizer means for polarizing according to a second polarization axis transverse to the first polarization axis infra-red radiation received thereby from an illuminated tooth.

17-20. (canceled)

21. The apparatus according to claim 1 in which the infra-red pixel sensor means is responsive to said returned infra-red light to generate image pixel values for a reference image of the illuminated tooth using reference infra-red light and not first infra-red light nor second infra-red light, and to provide such image pixel values for use and in which the data processor means is arranged to use one or more image pixel values of the reference image to calculate a reference reflectance value associated with the part, and to determine the measure of the degree of enamel lesion (Sₑ) and/or dentin lesion (S_{d}) present in the part using the reference reflectance value.

22-23. (canceled)

24. The apparatus according to claim 1 in which the first wavelength value is between 1300 nm and 1550 nm, and the second wavelength value is between 1550 nm and 1800 nm.

25. The apparatus according to claim 1 in which the illumination means is arranged to deliver full-field illumination to the tooth to be imaged and in which the infra-red pixel sensor means is arranged to detect or capture a full-field image of the tooth.

26. A method for imaging a tooth including:
generating first infra-red light with a first wavelength having a value within a range of values corresponding to an infra-red spectral absorption band of water, generating second infra-red light with a second wavelength having a value within a range of values corresponding to an infra-red spectral reflection band characteristic of scattering from demineralised tooth enamel, and illuminating a tooth therewith;
receiving at infra-red pixel sensor means first and second infra-red light returned from an illuminated tooth and therewith generating image pixel values for a first image of the illuminated tooth using first infra-red light and not second infra-red light and generating image pixel values for a second image of the illuminated tooth using second infra-red light and not first infra-red light, and providing such image pixel values for use; and
in respect of a given part of the imaged subject, calculating a first reflectance value associated with the part using one or more image pixel values of the first image, and calculating a second reflectance value associated with the part using one or more image pixel values of the second image, and determining from the first and second reflectance values a measure of the degree of enamel lesion (Sₑ) and/or dentin lesion (S_{d}) present in the part.

27-43. (canceled)

44. The method according to claim 26 in which the first wavelength value is between 1300 nm and 1550 nm, and the second wavelength value is between 1550 nm and 1800 nm.

45. (canceled)

46. The method according to claim 26 including calculating a measure (S_{carries}) of the degree of caries present in the part using said measure of the degree of enamel lesion (Sₑ) and said measure of the degree of dentin lesion (S_{d}).

47. (canceled)

48. A computer program product comprising a computer-readable medium containing computer executable instructions which implement the method of claim 26 when executed on a computer.

49. A computer program containing computer executable instructions which implement the method of claim 26 when executed on a computer.

50-54. (canceled)

55. An apparatus for imaging a tooth including:
illumination means arranged to generate first infra-red light with a first wavelength having a value within a range of values corresponding to an infra-red spectral absorption band of water, to generate second infra-red light with a second wavelength having a value within a range of values corresponding to an infra-red spectral reflection band characteristic of scattering from demineralised tooth enamel, and for illuminating a tooth therewith;
image data acquisition means arranged for receiving infra-red light originating from the illumination means and returned from an illuminated tooth, and including infra-red pixel sensor means responsive to said returned infra-red light to generate image pixel values for a first image of the illuminated tooth using first infra-red light and not second infra-red light and to generate image pixel values for a second image of the illuminated tooth using second infra-red light and not first infra-red light, and to provide such image pixel values for use; and
data processing means arranged in respect of a given part of the imaged subject to use one or more image pixel values of the first image to calculate a first reflectance value associated with the part, and to use one or more image pixel values of the second image to calculate a second reflectance value associated with the part, and to determine from the first and second reflectance values a measure of the degree of enamel lesion (Sₑ) and/or dentin lesion (S_{d}) present in the part;
wherein the data processing means is arranged to use said measure of the degree of enamel lesion (Sₑ) and said measure of the degree of dentin lesion (S_{d}) to calculate a measure (S_{caries}) of the degree of caries present in the part;
wherein the illumination means comprises first optical polarizer means for polarizing according to a first polarization axis infra-red radiation generated by the illumination means, and the image data acquisition means comprises second optical polarizer means for polarizing according to a second polarization axis transverse to the first polarization axis infra-red radiation received thereby from an illuminated tooth;
wherein the infra-red pixel sensor means is responsive to said returned infra-red light to generate image pixel values for a reference image of the illuminated tooth using reference infra-red light and not first infra-red light nor second infra-red light, and to provide such image pixel values for use and the data processor means is arranged to use one or more image pixel values of the reference image to calculate a reference reflectance value associated with the part, and to determine the measure of the degree of enamel lesion (Sₑ) and/or dentin lesion (S_{d}) present in the part using the reference reflectance value; and
wherein the first wavelength value is between 1300 nm and 1550 nm, and the second wavelength value is between 1550 nm and 1800 nm.

55. The method according to claim 46 further including spatially mapping the (S_{carries}) of the degree of caries present in the imaged subject using the calculated measure (S_{carries}).
